(19) United States
(12) Patent Application Publication
(10) Pub. No.: US 2011/0029516 A1
(43) Pub. Date: Feb. 3, 2011

(54) Web-Used Pattern Insight Platform

(75) Inventors: Qing Chang, Redmond, WA (US); Keiichiro Suzuki, Setagaya-ku (JP); Harini Sridharan, Bellevue, WA (US); Prashant Kamani, Issaquah, WA (US); Aleksandr Lyamtsev, Bellevue, WA (US); Mingyang Zhao, Issaquah, WA (US); Aditee Kumthekar, Kirkland, WA (US); Ashutosh Galande, Bellevue, WA (US); Charles Ainslie, Bellevue, WA (US); Staya Priya Hotani, Sammamish, WA (US); Reshma Mehta, Redmond, WA (US); Tho Van Nguyen, Redmond, WA (US); Yuan Gao, Bellevue, WA (US); Li Yang, Kirkland, WA (US); Jin Wu, Seattle, WA (US); Shuang Yang, Redmond, WA (US); Smridh Thapar, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/512,859

(22) Filed: Jul. 30, 2009

(51) Int. Cl. G06F 17/30

(52) U.S. Cl. 707/734; 707/E17.039

(57) ABSTRACT

A web site usage pattern insight platform may be provided. User behaviors associated with web page requests, including search queries, may be captured and analyzed to provide usage pattern insights. The pattern insights may be aggregated across a plurality of users and may be used to provide recommendations for improving a system that hosts the web pages.

### RELATED APPLICATIONS

Related U.S. patent application Ser. No. 12/492,704, filed on Jun. 26, 2009 entitled “Platform for Configurable Logging Instrumentation,” assigned to the assignee of the present application and having attorney docket number 14917.1301US01/MS327294.01, is hereby incorporated by reference.

Related U.S. patent application Ser. No. ______, filed on even date herewith entitled “Best-Bet Recommendations,” assigned to the assignee of the present application and having attorney docket number 14917.1303US01/MS327295.01, is hereby incorporated by reference.

Related U.S. patent application Ser. No. 12/492,675, filed on Jun. 26, 2009 entitled “Batched Transfer of Arbitrarily Distributed Data,” assigned to the assignee of the present application and having attorney docket number 14917.1304US01/MS327296.01, is hereby incorporated by reference.

Related U.S. patent application Ser. No. ______, filed on even date herewith entitled “Dynamic Information Hierarchies,” assigned to the assignee of the present application and having attorney docket number 14917.1305US01/MS327316.01, is hereby incorporated by reference.

Related U.S. patent application Ser. No. ______, filed on even date herewith entitled “Load-Balancing and Scaling for Analytics Data,” assigned to the assignee of the present application and having attorney docket number 14917.1306US01/MS327318.01, is hereby incorporated by reference.

### BACKGROUND

A web usage pattern insight platform provides management of an information system and its content. In some situations, analytics data for a large web site can consume large amounts of storage and overwhelm users with information overload. For example, user behavior can de difficult to quantify and analyze for relevant feedback, particularly as systems scale upwards. Obtaining insights based on this behavior can require significant human effort and risks operator bias and error. Furthermore, as the amount of data increases, any human-realizable insights become too shallow or out of date to be useful.

### SUMMARY

A web usage pattern insight platform may be provided. This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

A web site usage pattern insight platform may be provided. User behaviors associated with web page requests, including search queries, may be captured and analyzed to provide usage pattern insights. The pattern insights may be aggregated across a plurality of users and may be used to provide recommendations for improving a system that hosts the web pages.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIG. 2 is a flow chart of a method for providing a web usage pattern insight platform; and

FIG. 3 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

A web usage pattern insight platform may be provided. Consistent with embodiments of the present invention, user behaviors associated with both client and server devices may be captured and analyzed to provide various insights that may be used to improve users' experiences with a web site. Behaviors such as counting the number of times a page is loaded, user dwell times, and page element interactions may be logged by the insight platform, analyzed, and aggregated into behavior reports with recommendations to improve site performance and utility. Multi-dimensional reports of behavior patterns may then be presented to site administrators. For example, trends may be identified in user traffic that may result in hardware upgrade recommendations, with in depth details available to the administrator through searches and filtering.

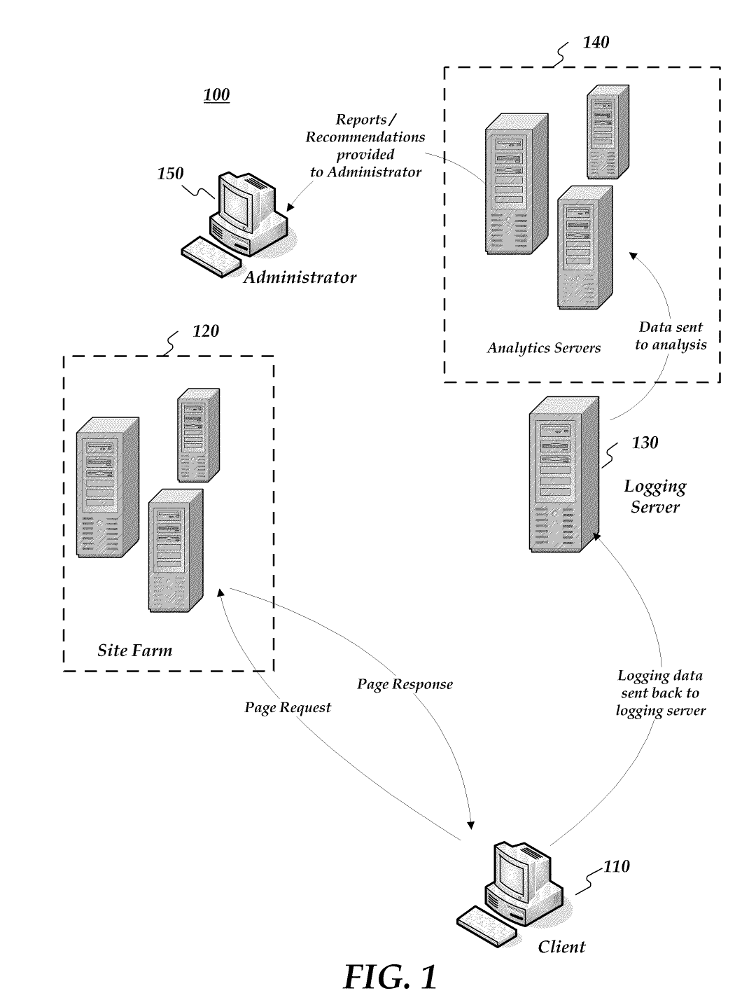

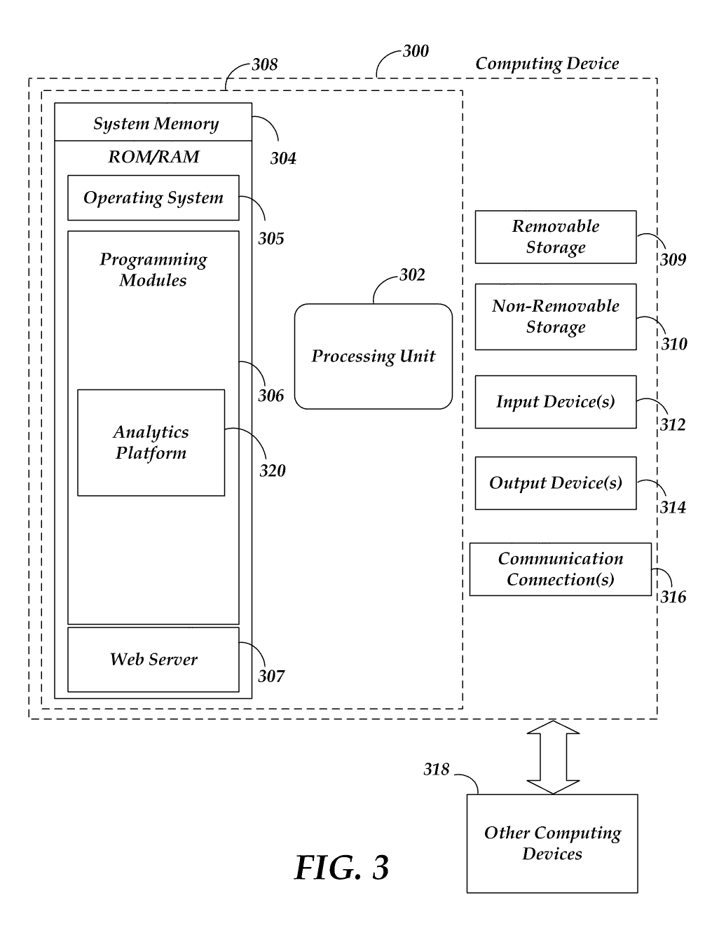

FIG. 1 is a block diagram of an operating environment 100. Operating environment 100 may comprise a client 110, a web site farm 120, a logging server 130, an analytics server 140, and a site administration device 150. Client 110, logging server 130, analytics server 140, and site administration device 150 may comprise, for example, a computing device 300 such as that described in greater detail below with respect to FIG. 3. Web site farm 120 may comprise one and/or a plurality of server computers each comprising a computer such as computing device 300 operative to host web pages associated with one and/or more web sites. Client 110, web site farm 120, logging server 130, analytics server 140, and/or site administration device 150 may be in communication with each other over a computing network or other communications medium. For example, client 110 may be operative to request and retrieve a web page from a web server associated with site farm 120 via the network and send captured user behaviors to logging server 130.

The retrieved web page may comprise a plurality of rendering instructions encoded in a markup language, such as HyperText Markup Language (HTML). The markup language may provide a means to describe the structure of text-based information in a document by identifying the structure of text elements as links, headings, paragraphs, lists. The markup language may also supplement the text with objects such as form controls, images, and executable scripts. Executable scripts may enable programmatic access to other objects on the page and to hardware and/or software associated with client 110. For example, a logging object may be operative to detect activities associated with user interface devices attached to client 110, such as a keyboard and/or mouse, and store the detected activity on a local storage device, such as RAM and/or a hard drive.

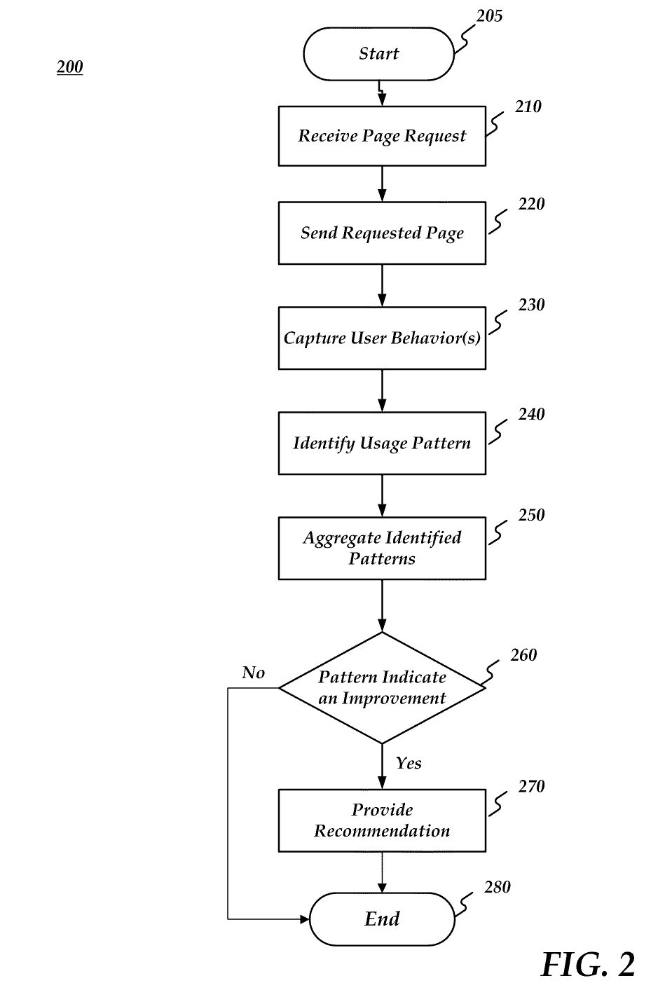

FIG. 2 is a flow chart setting forth the general stages involved in a method 200 consistent with an embodiment of the invention for providing a web site usage pattern insight platform. Method 200 may be implemented using a computing device 300 as described in more detail below with respect to FIG. 3. Ways to implement the stages of method 200 will be described in greater detail below. Method 200 may begin at starting block 205 and proceed to stage 210 where computing device 300 may receive a request for a web page. For example, client 110 may request a web page from a server associated with site farm 120. The request may comprise a uniform resource locator (URL) associated with the web page, and may comprise other properties such as form element options, web application commands, search queries, browser application properties (e.g. a session ID and an application name), and/or a referral page's identifier.

Method 200 may then advance to stage 220 where computing device 300 may send the requested page to client 110. For example, site farm 120 may locate the page at the request's URL and transmit the page via a network. A server associated with site farm 120 may also process properties associated with the request. For example, site farm 120 may process a search query by providing a plurality of search results and/or process form element options and provide a response according to those options.

From stage 220, where computing device 300 sent the requested page to the requesting client, method 200 may advance to stage 230 where computing device 300 may capture a user behavior associated with the requested page. User behaviors associated with either and/or both of the web server and the requesting client may be captured. For example, on the server side, a server-side logging object may increment a hit counter associated with the requested page and/or track an amount of bandwidth and/or storage used by pages stored on site farm 120. On the client side, client 110 may comprise a client-side logging object operative to log whether a user bookmarks, saves, and/or prints the page and/or a search result, a time at which client 110 selects a new page to view, whether or not client 110 ends a search on a result received from site farm 120.

Consistent with embodiments of the invention, captured user behaviors may be stored from client 110 and/or site farm 120 to a different computing device, such as logging server 130. Logging server 130 may be co-located at site farm 120 or may be located at a geographically distinct site.

Computing device 300 may also categorize each captured user behavior and/or associate user information with each captured behavior. For example, a plurality of user behaviors may be associated with a common identifier, such as a user ID. Categories may comprise, for example, inventory, traffic, and/or search. For example, inventory behaviors may comprise such elements as a number of servers associated with site farm 120, a number of sites, applications, and/or pages hosted on site farm 120, and/or an amount of free/used memory on servers associated with site farm 120. Traffic behaviors may comprise elements such as bandwidth used, page hit counts, referrer counts and identifiers. Search behaviors may comprise elements such as a count and/or list of search queries, numbers of results returned for any and/or all search queries, and/or numbers of failed queries.

From stage 230, method 200 may advance to stage 240 where computing device 300 may analyze the captured user behavior(s) to identify usage patterns associated with the requested page and/or web site. Analytics server 140 may process a single user's captured behaviors to identify patterns associated with a single page request and/or the user's interactions with several pages hosted by site farm 120.

From stage 240, method 200 may advance to stage 250 where computing device 300 may aggregate patterns identified from behaviors associated with multiple users. For example, analytics server 140 may aggregate page hits from multiple users to provide a total hit count for a web page. Computing device 300 may provide a report of the identified behaviors, such as to site administrator 150.

Consistent with embodiments of the invention, behaviors may be analyzed to identify multiple usage patterns and/or trends. For example, a particular search query may not return any search results or may return results that a user does not select to follow. A usage pattern of rejecting the results and/or repeating or revising the search may be identified. Computing device 300 may provide a report listing any and/or all of the queries that return unsatisfactory results. Aggregating the queries may identify variants and/or general subject areas that may benefit from improvement.

For another example, computing device 300 may provide a report detailing which pages are being hit and/or trends in traffic volume for pages and/or sites. The report may, for example, help direct higher revenue ads to popular pages and/or help direct system upgrades (e.g. memory and/or bandwidth) to improve availability. A report may help identify which day of the week has the most and/or least page hits.

Usage patterns may be centered around the idea of intent. A user who requests a page or issues a search query may have some intent that may not be visible to the system that's providing the data or the results from the search query. The system, such as a server of site farm 120, may see a key word that the user entered in a search query or the navigation that is happening on a particular page. Computing device 300 may analyze these user behaviors to try and identify the user's intent. For example, a search query may apply to two domains, such as a search query of “windows”. The system may not be able to determine from the query term alone whether the user may mean building materials or the Windows® operating system. Analyzing the user's behavior patterns may comprise capturing the domains of the results returned on the search query and capturing the user's reactions to the results. For example, a user spending a longer time on results associated with exterior doors and windows while ignoring results associated with computer systems may identify the user's intent. Each time a user interacts with these results, the system may gain more and more insight into users' behaviors. For example, if most users select the same results, the system may place those results higher in the list of search results when the same query is entered.

Consistent with embodiments of the invention, a plurality of reports may be provided based on the captured behaviors and identified patterns. Each of the reports may be filtered by an accessing user, such as by specifying a date range, or a scope of pages for which to view data. Table 1 comprises a non-exhaustive list of example reports and Table 2 comprises a sample summary report. Reports and lists of identified patterns may be provided as a web page and/or a syndicated feed and may be customized according to a user to whom the report is provided. For example, an administrator may see more detailed statistics than an end-user requesting a publicly available report.

TABLE 1
Report List

| | |
|---|---|
| Report Type | Description and Factors |

Category: Traffic

| | |
|---|---|
| Number of Page Views | This report may show how many page views a web |
| | site gets per day. The report may be filtered and/or |
| | sorted for a user-configurable date range. A page |
| | view may be counted each time a client's visit to the |
| | web site generate a server page request. The report |
| | may illustrate trends associated with a traffic load, a |
| | traffic pattern of page views, and when peak/off peak |
| | times are. |
| Number of Unique Visitors | This report may show how many unique visitors |
| | visited a web site per selectable time period (e.g. |
| | day, hour, week, month). The report may illustrate |
| | trends associated with a total number of different |
| | visitors which viewed the web site in a given period, |
| | the visitor traffic patterns, and when peak/off peak |
| | times are. |
| Number of Referrers | This report may show how many referring instances |
| | a web site gets from external referral pages per day |
| | for a selectable date range. The report may illustrate |
| | trends associated with when the web site is getting |
| | the most number of referrers and traffic patterns of |
| | external referrers. |
| Top Pages | This report may show the most popular pages on a |
| | site based on number of times each page was |
| | viewed by visitors for a selectable date range. The |
| | report may illustrate trends associated with popularity |
| | between different pages on the website, clients' |
| | interests and preferences, pages that need |
| | improvements, or finding page views for specific |
| | pages to measure marketing effectiveness. |
| Top Visitors | This report may show top unique visitors who have |
| | visited pages on a web site for a selectable date |
| | range. The report may illustrate trends associated |
| | with understanding who has used the web site most |
| | and tailoring the web site to those top visitors' |
| | interests and needs. For anonymous visitors, traffic |
| | from different visitors with the same IP address may |
| | be differentiated. |
| Top Referrers | This report may show external referral pages that |
| | have contributed referring instances to pages on a |
| | web site. The report may illustrate trends associated |
| | with where external referrals to the web site came |
| | from, how visitors came to the web site, and analyze |
| | the effectiveness of external referring links to the |
| | web site. |
| Top Destinations | This report may show the most popular external |
| | pages clients went to after they left pages on a web |
| | site. The report may illustrate trends associated with |
| | visitors' traffic patterns after they leave the site and |
| | analyzing the effectiveness of referrals to other sites. |
| Top Browsers | This report may show the most popular browser |
| | types and versions used by visitors on a web site. |
| | The report may illustrate trends associated with |
| | technologies the visitors use, and may determine |
| | how to configure the web site for optimal viewing. |

Category: Search

| | |
|---|---|
| Number of Queries | This report may show how many search queries a |
| | web site gets per day for a selectable date range. |
| | The report may illustrate trends associated with |
| | search query volume trends and may determine |
| | when peak/off peak times are. |
| Top Queries | This report may show the most popular search |
| | queries issued on a site for a selectable date range. |
| | The report may illustrate trends associated with |
| | information the visitors are looking for in the web site. |
| Failed Queries | This report may show search queries that returned |
| | no search results or received zero or low click- |
| | through. The report may illustrate trends associated |
| | with search queries that resulted user dissatisfaction. |
| Best Bet Usage | This report may show the number of click-throughs |
| | Best Bet URLs received for the search keywords. |
| | Best Bets may be added manually and/or added by |
| | accepting system recommendations in a Best Bet |
| | Suggestions report. |
| Best Bet Suggestions | This report may show recommendations of Best Bet |
| | URLs for certain search keywords. |

Category: Inventory

| | |
|---|---|
| Storage Usage | This report may show a trended snapshot of storage |
| | usage of a site collection for the date range reported. |
| | The report may illustrate a storage growth trend of |
| | the site collection. |
| Number of sites | This report may show a trended snapshot of a |
| | number of sites a site collection has for the date |
| | range reported. The report may illustrate a growth |
| | trend of site creation and deletion in the site |
| | collection. |
| Number of site collections | This report may show a trended snapshot of a |
| | number of site collections a Web Application has for |
| | the date range reported. The report may illustrate a |
| | growth trend of site collection creation and deletion in |
| | the Web Application. |
| Number of Lists | This report may show a trended snapshot of a |
| | number of Lists the site collection has for the date |
| | range reported. The report may illustrate a growth |
| | trend of List creation and deletion in the site |
| | collection. |
| Number of Libraries | This report may show a trended snapshot of the |
| | number of Libraries a site collection has for the date |
| | range reported. The report may illustrate a growth |
| | trend of Library creation and deletion in the site |
| | collection. |
| Top site Templates | This report may show popular site templates used to |
| | create sites in a site collection for the date range |
| | reported. The report may illustrate a current usage |
| | of the site template inventory, and help optimize |
| | future investments of site templates. |
| Top site collection Templates | This report may show popular site collection |
| | templates used to create site collections in a Web |
| | Application for the date range reported. The report |
| | may illustrate a current usage of the site collection |
| | template inventory and help optimize future |
| | investments of site collection templates. |
| Top site Languages | This report may show top site languages based on |
| | number of sites created using each language for the |
| | date range reported. The report may illustrate a site |
| | language distribution in the site collection. |
| Top site Product Versions | This report may show top site product versions |
| | based on a product version property of each site in a |
| | site collection for the date reported. The report may |
| | illustrate a site product version distribution in the site |
| | collection, especially in gradual upgrade scenarios. |
| Top List Templates | This report may show popular list templates used to |
| | create Lists in the site collection for the date range |
| | reported. The report may illustrate a current usage of |
| | the list template inventory and help optimize future |
| | investments of list templates. |
| Top Library Templates | This report may show popular library templates used |
| | to create Libraries in a site collection for the date |
| | range reported. The report may illustrate a current |
| | usage of the library template inventory and help |
| | optimize future investments of library templates. |

TABLE 2
Summary Report

| | | Value | Value | |
|---|---|---|---|---|
| | | (Current) | (Previous) | |
| Category | | (from <xx/xx/xxxx> | (from <xx/xx/xxxx> to | |
| Traffic | Metrics | to <xx/xx/xxxx>) | <xx/xx/xxxx>) | Trend |
| | Total Page Views | 1000 | 1200 | −20% |
| | Average Page Views | 120 | 100 | +20% |
| | Per Day | | | |
| | Total Unique Visitors | 50 | 60 | −20% |
| | Average Unique | 12 | 10 | +20% |
| | Visitors Per Day | | | |
| | Total Referrers | 300 | 200 | +50% |
| | Average Referrers Per | 48 | 48 | 0% |
| | Day | | | |

From stage 250, where computing device 300 aggregated the identified patterns into a usage report, method 200 may advance to stage 260 where computing device 300 may determine whether the identified usage patterns may indicate an improvement that may be made to the page and/or site. For example, analytics server 140 may determine which search queries result in unsatisfactory search results and rank them according to their popularity.

If, at stage 260, computing device 300 determines that an improvement may be made, method 200 may advance to stage 270 where computing device 300 may provide a recommendation. For example, is analytics server 140 identifies a search query that returns unsatisfactory results, analytics server 140 may recommend adding content to the page and/or website or adding suggested search results to the site. For another example, if a site experiences a high server load during an indentified time of day, analytics server 140 may recommend reducing back-end processing load (e.g. backups and maintenance) during this time. Once computing device 300 provides a recommendation in stage 270, or if no improvements are determined in stage 260, method 200 may end at stage 280.

An embodiment consistent with the invention may comprise a system for providing web usage pattern insights. The system may comprise a memory storage and a processing unit coupled to the memory storage. The processing unit may be operative to capture a plurality of user behaviors, analyze the plurality of user behaviors to identify a usage pattern, and provide a report of the identified usage pattern. The report may be customized for various users, such as by restricting some behaviors, statistics, and/or patterns from some users. Users may also provide attributes, such as through a user interface element, for filtering the reports. Such attributes may comprise, for example, a user, a date range, a content type, a search scope, and an exclusion criteria.

Another embodiment consistent with the invention may comprise a system for providing web usage pattern insights. The system may comprise a memory storage and a processing unit coupled to the memory storage. The processing unit may be operative to capture a plurality of usage data associated with a web page request, categorize each of the plurality of usage data, analyze the plurality of usage data to identify a usage pattern, and provide a report of the identified usage pattern. The identified usage patterns and the report may be categorized based on the source and/or application of the underlying usage data. Categories may comprise, for example, traffic, search, and inventory. The processing unit may be further operative to configure the report's layout, such as by specifying fonts, colors, and/or templates for web-based reports.

Yet another embodiment consistent with the invention may comprise a system for providing a web site usage insight platform. The system may comprise a memory storage and a processing unit coupled to the memory storage. The processing unit may be operative to receive a request for a web page from a client, send the requested web page to the client, capture a plurality of user behaviors associated with the client, identify at least one usage pattern according to the captured plurality of user behaviors, aggregate the identified at least one usage pattern with a plurality of other usage patterns identified according to a plurality of other user behaviors associated with at least one other client, determine whether the aggregated usage patterns indicate a potential system improvement according to at least one configurable metric, and provide a recommendation for improving the system

FIG. 3 is a block diagram of a system including computing device 300. Consistent with an embodiment of the invention, the aforementioned memory storage and processing unit may be implemented in a computing device, such as computing device 300 of FIG. 3. Any suitable combination of hardware, software, or firmware may be used to implement the memory storage and processing unit. For example, the memory storage and processing unit may be implemented with computing device 300 or any of other computing devices 318, in combination with computing device 300. The aforementioned system, device, and processors are examples and other systems, devices, and processors may comprise the aforementioned memory storage and processing unit, consistent with embodiments of the invention. Furthermore, computing device 300 may comprise an operating environment for system 100 as described above. System 100 may operate in other environments and is not limited to computing device 300.

With reference to FIG. 3, a system consistent with an embodiment of the invention may include a computing device, such as computing device 300. In a basic configuration, computing device 300 may include at least one processing unit 302 and a system memory 304. Depending on the configuration and type of computing device, system memory 304 may comprise, but is not limited to, volatile (e.g. random access memory (RAM)), non-volatile (e.g. read-only memory (ROM)), flash memory, or any combination. System memory 304 may include operating system 305, one or more programming modules 306, and may include a web server 307. Operating system 305, for example, may be suitable for controlling computing device 300's operation. In one embodiment, programming modules 306 may include an analytics platform 320. Furthermore, embodiments of the invention may be practiced in conjunction with a graphics library, other operating systems, or any other application program and is not limited to any particular application or system. This basic configuration is illustrated in FIG. 3 by those components within a dashed line 308.

Computing device 300 may have additional features or functionality. For example, computing device 300 may also include additional data storage devices (removable and/or non-removable) such as, for example, magnetic disks, optical disks, or tape. Such additional storage is illustrated in FIG. 3 by a removable storage 309 and a non-removable storage 310. Computer storage media may include volatile and nonvolatile, removable and non-removable media implemented in any method or technology for storage of information, such as computer readable instructions, data structures, program modules, or other data. System memory 304, removable storage 309, and non-removable storage 310 are all computer storage media examples (i.e memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 300. Any such computer storage media may be part of device 300. Computing device 300 may also have input device(s) 312 such as a keyboard, a mouse, a pen, a sound input device, a touch input device, etc. Output device(s) 314 such as a display, speakers, a printer, etc. may also be included. The aforementioned devices are examples and others may be used.

Computing device 300 may also contain a communication connection 316 that may allow device 300 to communicate with other computing devices 318, such as over a network in a distributed computing environment, for example, an intranet or the Internet. Communication connection 316 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 304, including operating system 305. While executing on processing unit 302, programming modules 306 (e.g. analytics platform 320) may perform processes including, for example, one or more method 200's stages as described above. The aforementioned process is an example, and processing unit 302 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing web usage pattern insights, the method comprising:
capturing a plurality of user behaviors;
analyzing the plurality of user behaviors to identify a usage pattern;
categorizing the usage pattern; and
providing a report of the identified usage pattern.

2. The method of claim 1, wherein at least one of the user behaviors comprises a user behavior captured by a client-side logging object.

3. The method of claim 1, wherein at least one of the user behaviors comprises a user behavior captured by a server-side logging object.

4. The method of claim 1, wherein the provided report comprises a plurality of aggregated behavior statistics.

5. The method of claim 4, further comprising customizing the provided report according to an attribute associated with a user to whom the report is provided.

6. The method of claim 5, wherein customizing the provided report according to an attribute associated with a user to whom the report is provided comprises restricting at least one of the aggregated behavior statistics from view by the user.

7. The method of claim 5, wherein customizing the provided report according to an attribute associated with a user to whom the report is provided comprises allowing the user to filter the plurality of aggregated behavior statistics.

8. The method of claim 1, further comprising recommending a change to a web site associated with the plurality of user behaviors.

9. The method of claim 1, further comprising providing a syndication feed of the analyzed user behaviors.

10. The method of claim 1, wherein the analyzed plurality of user behaviors comprises at least one of the following: a search query returning no results, and a search query returning no user-accepted results.

11. The method of claim 10, wherein the usage pattern identified from the analyzed plurality of user behaviors comprises a dissatisfaction with a search query.

12. The method of claim 11, wherein the provided report comprises a list of a plurality of search queries for which users are dissatisfied.

13. The method of claim 12, further comprising providing a recommendation to add content associated with at least one of the plurality of search queries for which users are dissatisfied.

14. A computer-readable medium which stores a set of instructions which when executed performs a method for providing web usage pattern insights, the method executed by the set of instructions comprising:
capturing a plurality of usage data associated with a web page request;
categorizing each of the plurality of usage data;
analyzing the plurality of usage data to identify a usage pattern; and
providing a report of the identified usage pattern.

15. The computer-readable medium of claim 14, wherein categorizing each of the plurality of usage data comprises associating each of the plurality of usage data with at least one of the following categories: traffic, search, and inventory.

16. The computer-readable medium of claim 14, wherein providing the report of the identified usage pattern comprises providing a user interface element for receiving a filtering criteria.

17. The computer-readable medium of claim 16, wherein the filtering criteria comprises at least one of the following: a user associated with at least one of the plurality of usage data, a content type, a search scope, a date range, and an exclusion criteria.

18. The computer-readable medium of claim 14, further comprising configuring a layout of the provided report.

19. The computer-readable medium of claim 14, further comprising providing a syndication feed of identified usage patterns.

20. A system for providing a web site usage insight platform, the system comprising:
a memory storage; and
a processing unit coupled to the memory storage, wherein the processing unit is operative to:
receive a request for a web page from a client, wherein the request for the web page comprises at least one search query;
send the requested web page to the client, wherein the requested web page comprises at least one search result;
capture a plurality of user behaviors associated with the client, wherein the captured plurality of user behaviors comprises at least one first user behavior captured by the system and at least one second user behavior captured by the client;
identify at least one usage pattern according to the captured plurality of user behaviors;
aggregate the identified at least one usage pattern with a plurality of other usage patterns identified according to a plurality of other user behaviors associated with at least one other client;
determine whether the aggregated usage patterns indicate a potential system improvement according to at least one configurable metric; and
in response to determining that the aggregated usage patterns indicate a potential system improvement according to at least one configurable metric, provide a recommendation for improving the system.
